(19) United States
(12) Patent Application Publication
(10) Pub. No.: US 2006/0254720 A1
(43) Pub. Date: Nov. 16, 2006

(54) Office accessory

(76) Inventor: Bernd Loibl, Klettgau (DE)

Correspondence Address: BERENATO, WHITE & STAVISH, LLC, 6550 ROCK SPRING DRIVE, SUITE 240, BETHESDA, MD, 20817, US

(21) Appl. No.: 11/210,775

(22) Filed: Aug. 25, 2005

(30) Foreign Application Priority Data
May 13, 2005 (DE) 20 2005 007 860.3

(51) Int. Cl. B32B 38/04

(52) U.S. Cl. 156/530; 156/510; 156/516

(57) ABSTRACT

An office accessory for processing sheet material such as paper and/or films has a support plate to support the sheet material during the processing operation. At least one cutting device is associated with the support plate. The office accessory additionally comprises at least one laminating device for laminating sheet material to at least one film.

### CROSS-REFERENCE TO RELATED APPLICATIONS AND CLAIM TO PRIORITY

This application is based upon utility model application number 20 2005 007 860.3, filed May 13, 2005 in the Federal Republic of Germany, the disclosure of which is incorporated herein by reference and to which priority is claimed.

### FIELD OF THE INVENTION

The invention concerns an office accessory for processing sheet material such as paper and/or films, having a support plate to support the sheet material during the processing operation and having at least one cutting device associated with the support plate.

### BACKGROUND OF THE INVENTION

Office accessories of the aforementioned kind are used for trimming of sheet material such as paper, films, or photographs. In the existing art they are embodied as cutting units only, and comprise a support plate on which the sheet material to be trimmed can be placed for the cutting operation. Arranged at one edge of the support plate is a cutting device, usually in the form of a guillotine cutting device. To allow photographs to be trimmed more cleanly and more accurately, cutting units are known that comprise, instead of a guillotine cutting device, a rotary cutting device in which a rotatably mounted circular knife is mounted on a knife carriage that is displaceable on a guide bar. In the case of the cutting unit according to EP 1 475 201 A1, guillotine cutting devices and rotary cutting devices are combined with one another, either by arrangement on two parallel sides of the support plate or by interchangeable association with one side of the support plate.

Known in addition thereto are laminating units for encapsulating documents—for example brochures, legal documents, identification cards, etc.—between two transparent plastic films in order to protect them from soiling and damage. For the laminating operation, the sheet material can be placed between two loose films.

Instead, however, the two films can also be present in the form of a laminating pouch, in which the two laminating films are heat-sealed to one another on two or three side edges. The sheet material to be laminated can be placed into the laminating pouch. The laminating films are transparent, so that the sheet material remains visible and readable. They retain that transparency even after heat-sealing. The laminating films are usually embodied, for that purpose, as so-called composite films (cf. Ullmanns Enzyklopädie der Technischen Chemie [Encyclopedia of industrial chemistry], 4th ed., Vol. 11, 1976, page 684, and Vol. 14, 1977, page 249).

The laminating units used for the laminating operation comprise a housing having a front side and a back side. A flat feedthrough conduit, which has on the front side an insertion opening and on the back side an exit opening for the combination of sheet material and films, extends between the front and back sides. Arranged inside the housing is a laminating device that usually comprises two heated laminating rollers, which are driven in the conveying direction and between which the combination of sheet material and films travels. The laminating rollers thereby apply pressure onto the combination passing through, and at the same time heat the films. The films thus adhesively bond to the sheet material being encapsulated and, at the edges, to one another. The laminating rollers ensure that the combination of sheet material and films is transported through the laminating unit to the exit opening.

Also known instead of thermally operating laminating units are simple laminating units, which require no electrical power delivery and in which the joining of the sheet material and films is brought about solely by the application of pressure. The films are equipped for this purpose, on the sides facing toward the sheet material, with a pressure-sensitive adhesive that is not self-adhesive, i.e. is activated only by the application of pressure. The combination of sheet material and films is compressed between the laminating rollers. The laminating rollers are driven manually.

### SUMMARY OF THE INVENTION

It is the object of the invention further to develop an office accessory of the kind cited initially.

According to the present invention, this object is achieved in that the office accessory comprises, in addition to the at least one cutting device, at least one laminating device for laminating sheet material to at least one film. The basic idea of the invention is therefore to combine two (or more) devices, having different functions, into one combined office accessory. This combination yields considerable advantages. For example, the space requirement of the office accessory according to the present invention is substantially smaller. Advantages in handling also result from the adjacent arrangement of the cutting device and laminating device. The trimming of a sheet in order to prepare for a subsequent laminating operation can be performed with no change in location, which is practical and saves time.

In an embodiment of the invention, provision is made for the laminating device to be arranged or attachable on one side of the support plate, its insertion opening for the introduction of sheet material and film(s) preferably facing toward the support plate, in particular in such a way that the lower side of the insertion opening is flush with the upper side of the support plate. The support plate thus assumes a dual function, since it can perform its supporting function both during the cutting operation and upon insertion of the combination of sheet material and film. This results in a particularly small space requirement.

If the laminating device is arranged on one side of the support plate, the at least one cutting device should be arranged or attachable on a different side of the support plate. It is useful in this context if the laminating device is arranged or attachable on a side of the support plate that extends transversely to the side on which the at least one cutting device is arranged or attachable.

The cutting device can be embodied as a guillotine cutting device that comprises a pivotably mounted knife arm having a blade held thereon and a counterknife held in stationary fashion on the support plate. Alternatively, the cutting device can also be embodied as a rotary cutting device that comprises a knife carriage displaceable on a guide bar and a circular knife rotatably mounted on that carriage. In a particularly preferred embodiment, however, both alternatives can also be combined with one another on the office accessory, for example in such a way that the guillotine cutting device is arranged or attachable on one side of the bed and the rotary cutting device on the other side of the bed, advantageously so that the cutting devices extend parallel to one another and the laminating device is arranged or attachable, between them, on a side extending transversely thereto.

It is particularly useful if the cutting device(s) and/or the laminating device is or are attached detachably on the support plate; provision can additionally be made for the cutting device(s) to be embodied interchangeably with one another and/or with the laminating device. For this purpose, the support plate on the one hand and the cutting device(s) and/or laminating device on the other hand can comprise complementary retaining elements with which it or they is or are attachable or attached on one side of the bed.

The retaining elements used can comprise latch devices which usefully are embodied in such a way that they are self-latching upon attachment of the cutting device(s) or laminating device, but require a release actuation of the latch device upon removal.

The laminating device can be embodied as a hot laminating device, in order to make possible heat-sealing of the sheet material and the films that are to be thermally activated. This requires, however, an electrical connection for the heating device, which connection can additionally be used to drive the laminating rollers in motorized fashion. An electrical connection can be dispensed with if the laminating device is embodied as a cold laminating device in which the laminating rollers are drivable manually, for example via a rotary handle. It is understood that cold laminating devices can also have an electrical drive system for the laminating rollers. Conversely, however, hot laminating devices can also have a manually actuatable roller drive system.

Provision is further made, according to the invention, for at least one storage compartment to be provided beneath the support plate, preferably at a horizontal spacing from the at least one cutting device. This creates the possibility of using, as a storage compartment, the space beneath the support plate hitherto unused in cutting units. Office accessories such as staple removers, staplers, or the like, but also other office items such as staples, writing instruments, or sheet materials such as paper or films, can be accommodated in this storage compartment without an additional space requirement. This creates circumstances such that the operations arising before or after a cutting and/or laminating operation can be performed contemporaneously and without delay, and the space around the office accessory remains clear for actual office work.

The storage compartment is preferably openable by the fact that the support plate is at least partly removable from the region of the storage compartment, for example by at least partly swinging it up or displacing it laterally. For the storage of items sensitive to atmospheric influences, for example photographic papers, provision can be made for at least one storage compartment, or a portion thereof, to be sealed in airtight fashion. This can be accomplished, for example, in that the storage compartment contains or comprises an airtight but openable box.

The invention furthermore provides for the storage compartment to be subdivided into sub-compartments in order to store different objects separately from one another and thus in orderly fashion. It is further proposed that the support plate be at least transparent in the region of the storage compartment. As a result, it is possible to determine at a glance whether the desired office item is in fact present in the storage compartment.

The size of the storage compartment should make the best possible use of the space beneath the support plate. It is therefore recommended to make available at least 50% of the support plate for the storage compartment located therebeneath, since the space beneath the support plate is usually empty, and the area for the reception of office items might not be large enough. In particular, the storage compartment should also be large enough that sheet material provided for the laminating operation, in particular the films necessary therefor, can be stored therein.

Lastly, provision is made according to the invention for equipping the office accessory with an independent power supply in the form of a battery or rechargeable battery, for example in order to provide electrical current to the laminating device.

### BRIEF DESCRIPTION OF THE DRAWINGS

The invention is illustrated in more detail, with reference to exemplifying embodiments, in the drawings, in which:

FIG. 1 is a perspective view of a first office accessory having a guillotine cutting device and a hot laminating device;

FIG. 2 is a perspective view of the first office accessory with the storage compartment open;

FIG. 3 is a perspective view of a second office accessory having a guillotine cutting device and a cold laminating device;

FIG. 4 is a perspective view of a third office accessory having a guillotine and a rotary cutting device, and having a attachable laminating device;

FIG. 5 is a perspective view of a fourth office accessory having interchangeable laminating and cutting devices.

### DETAILED DESCRIPTION OF THE PREFERRED EMBODIMENT(S)

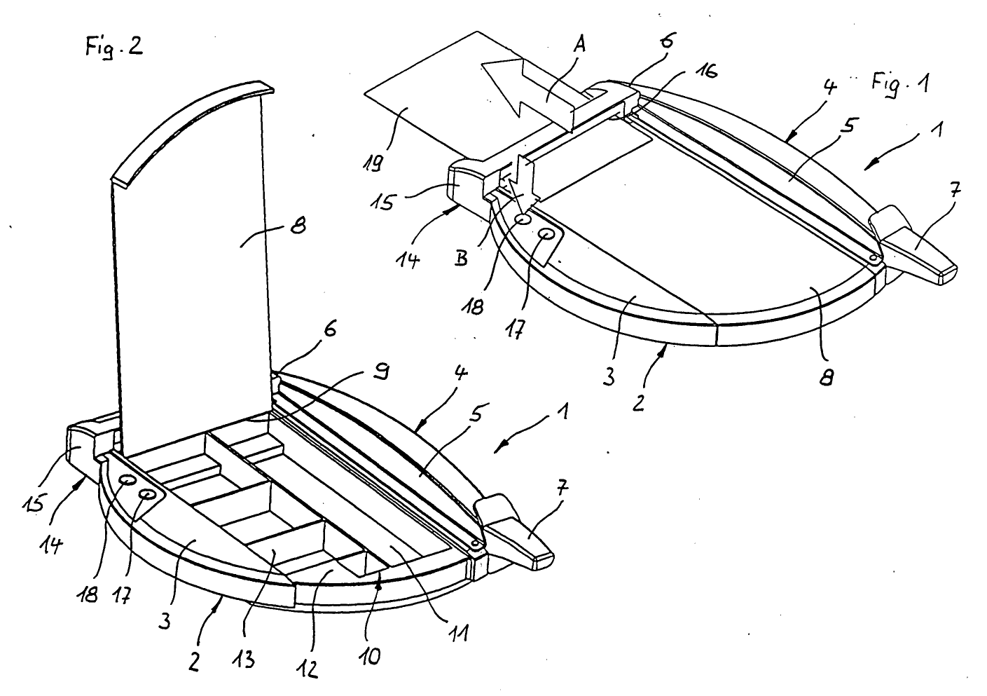

Office accessory 1 depicted in FIGS. 1 and 2 comprises a frame plate 2 whose horizontal upper side forms a support plate 3 for the placement of sheet material. A guillotine cutting device 4 is located on the upper side of frame plate 2.

Guillotine cutting device 4 comprises a knife arm 5 that is mounted pivotably, in a bearing 6, about a horizontal axis extending transversely to the longitudinal side there. Knife arm 5 is equipped on its lower side, substantially over its entire length, with a cutting knife that is concealed in this view. Configured at the free end of knife arm 5 is a handle 7 with which knife arm 5 can be pivoted upward and downward about bearing 6. In the position shown, knife arm 5 is located in the lower terminal position.

The larger portion of support plate 3 is separated from the remaining portion, and forms a cover plate 8. It is mounted upwardly pivotably on one side via a hinge 9, about an axis that extends parallel to the axis of bearing 6 for knife arm 5. Cover plate 8 can therefore be pivoted out of the closed position depicted in FIG. 1 into the approximately vertical position shown in FIG. 2. Located beneath cover plate 8 is a storage compartment 10 which is embodied as a removable storage tray 12 that has a bottom 11 on the lower side, is open at the top, and is hooked into frame plate 2. Storage tray 12 is subdivided by vertical ribs (labeled 13 by way of example) in such a way that storage compartment 10 comprises multiple sub-compartments separated from one another. Office items or small office accessories can then be accommodated in these sub-compartments. Sheet material can also be placed above the sub-compartments and below cover plate 8.

Attached on the side of frame plate 2 that extends, adjacent to bearing 6, transversely to the side on which guillotine cutting device 4 is arranged, is a hot laminating device 14. It has a housing 15 penetrated, in the direction of arrow A, by a feedthrough conduit of low height. The feedthrough conduit has an insertion opening 16 on the side facing toward support plate 3, and an exit opening on the side facing away from it.

Arranged in housing 15, one above another, are two laminating rollers (not visible here) that form between them a laminating gap that extends over the width of the feedthrough conduit. The laminating rollers are heated, and are driven in opposite direction in such a way that their roller surfaces move in the roller gap toward the exit opening.

Office accessory 1 comprises control buttons 17, 18 with which hot laminating device 14 can be switched on and off. Heating of the laminating rollers is controlled via the one control button 17, while pressing the other control button 18 in the direction of arrow B causes the drive system of the laminating rollers to be switched on, and also to be switched off again after the laminating operation.

For a cutting operation, the sheet material to be trimmed is placed onto support plate 3, and knife arm 5 is pivoted upward about bearing 6. The sheet material is then shifted sufficiently that the portion to be cut off projects beyond support plate 3 on the side on which guillotine cutting device 4 is attached. Knife arm 5 is then pivoted downward about bearing 6 into the position shown.

For a laminating operation, a combination 19 of laminating films and sheet material to be laminated is placed onto support plate 3, and slid into insertion opening 16 until the laminating rollers grasp combination 19 of sheet material and films. The laminating rollers then transport this combination 19 through hot laminating device 14 in the direction of arrow A. In the laminating gap between the two laminating rollers, combination 19 is compressed and simultaneously heated sufficiently that a join between the films and sheet material, and also a join between the films at the edges, is brought about.

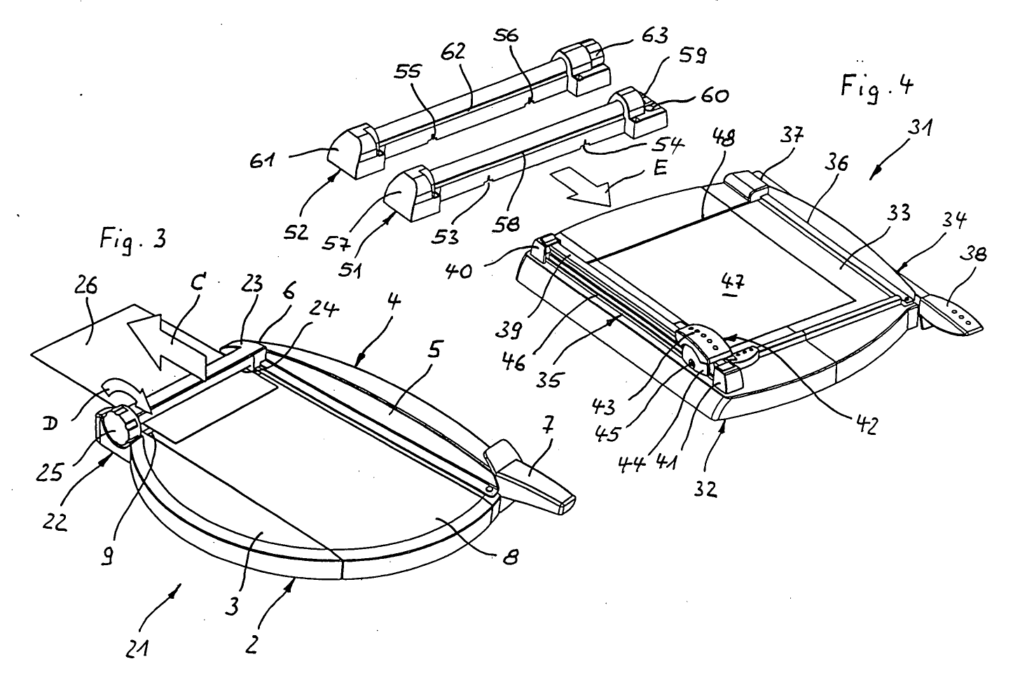

Office accessory 21 depicted in FIG. 3 comprises a cold laminating device 22. All the other parts of office accessory 21 match the corresponding parts of office accessory 1 according to FIGS. 1 and 2, so that the same reference characters have been used for those parts in FIG. 2, and reference is made, with regard to description of those parts, to the description above of office accessory 1 as shown in FIGS. 1 and 2.

Cold laminating device 22 is arranged at the same location as hot laminating device 11 in the case of office accessory 1 according to FIGS. 1 and 2. It comprises a housing 23 penetrated, in the direction of arrow C, by a feedthrough conduit of low height. The feedthrough conduit has an insertion opening 24 on the side facing toward support plate 3, and an exit opening on the side facing away from it.

Here as well, two laminating rollers arranged one above another, whose axes extend parallel to that of bearing 6, are provided inside housing 23. The laminating rollers form between them a laminating gap that extends over the width of the feedthrough conduit. The upper laminating roller is connected to an externally accessible rotary knob 25. The lower laminating roller is coupled to the upper one via a spur-gear linkage, in such a way that the two laminating rollers rotate in opposite directions.

A cutting operation proceeds as described with reference to office accessory 1, and the situation is similar for the laminating operation as well. For the latter, a combination 26 of sheet material to be laminated and films placed on both sides is placed onto support plate 3 and slid into insertion opening 24, in the direction of arrow C, until the front end of combination 26 enters the laminating gap. Rotary knob 25 is then rotated manually in the direction of arrow D. As a result, the laminating rollers are driven in opposite directions so that combination 26 of sheet material and films is transported in the direction of arrow C through cold laminating device 22. In the process, combination 26 is sufficiently compressed that the sheet material and films adhere to one another.

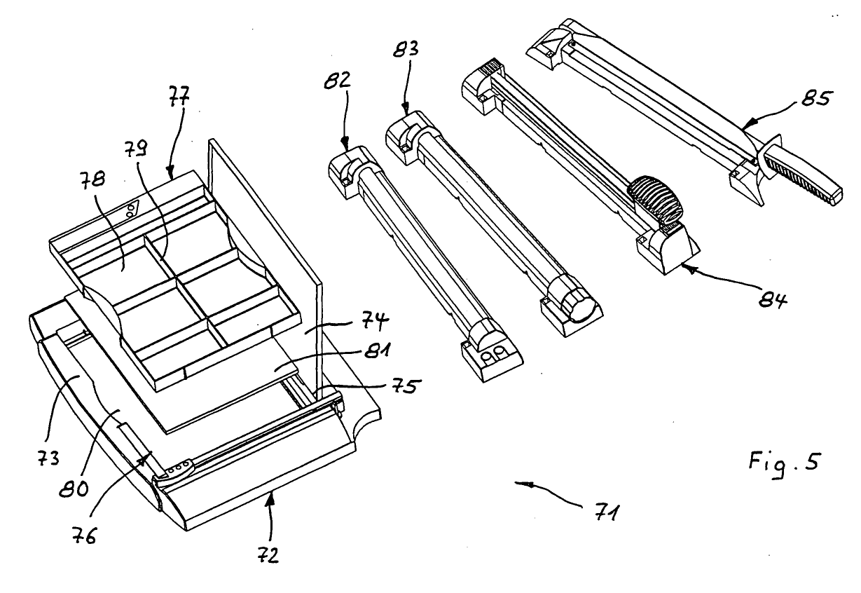

Office accessory 31 depicted in FIG. 4 comprises a frame plate 32, having a substantially rectangular base outline, whose horizontal upper side forms a support plate 33 for the placement of sheet material. A guillotine cutting device 34 is arranged on the upper longitudinal side, and a rotary cutting device 35 on the lower longitudinal side. The two cutting devices 34, 35 extend parallel to one another.

Guillotine cutting device 34 comprises a knife arm 36 that is mounted pivotably, in a bearing 37, about a horizontal axis extending transversely to the longitudinal side there. Knife arm 36 is equipped on its lower side, substantially over its entire length, with a cutting knife that is concealed in this view. Configured at the free end of knife arm 36 is a handle 38 with which knife arm 36 can be pivoted upward and downward. In the position shown, knife arm 36 is located in the lower terminal position.

Rotary cutting device 35 comprises a guide bar 39 that extends at a distance from support plate 33, parallel to the cutting edge and cutting direction of guillotine cutting device 34, between two holding blocks 40, 41. A knife carriage 42 is guided on guide bar 39 displaceably in the direction of the longitudinal axis of guide bar 39. It can be slid manually back and forth using handle 43.

A circular knife, not visible here because it is covered by a protective cap 44, is mounted rotatably on knife carriage 42. Mounting is accomplished about a horizontal axis 45 that extends transversely to the longitudinal axis of guide bar 39. The circular knife projects downward beyond knife carriage 42 and makes contact against a counterknife bar 46 that is recessed into support plate 33 and extends parallel to guide bar 39.

A portion of support plate 3 is separated from the remaining portion thereof, and forms a cover plate 47. Cover plate 47 is joined to the remaining portion of support plate 33 via a hinge 48, and can be swung upward about that hinge 48 from the horizontal position (as shown) flush with the remaining portion of support plate 33, similarly to the situation with office accessory 1 (see FIG. 2). Located beneath cover plate 47—as in the case of office accessories 1, 21 according to FIGS. 1 to 3—is a storage compartment that is embodied in the shape of a tray and is delimited on the lower side by a bottom. The storage compartment is open toward the top and is closed off by cover plate 47. The latter is of transparent configuration, so that the contents of the storage compartment are recognizable from outside.

The storage compartment is sufficiently large that paper can also be placed into it. The possibility moreover exists of setting into the storage compartment an airtight box, and placing therein, in protected fashion, objects (such as photographic papers) that are sensitive to atmospheric influences. A peripheral seal, with which an airtight closure can be achieved, can instead be provided between cover plate 47 and frame plate 32.

One of the two laminating devices 51, 52 is part of office accessory 31. One of the two laminating devices 51, 52 can in each case be joined removably to frame plate 32 on the side thereof toward which arrow E is pointing. Provided for that purpose on frame plate 32 and on laminating devices 51, 52 are complementary latch devices 53, 54, 55, 56 that latch to one another when inserted into one another. The laminating device 51 or 52 that is respectively joined to frame plate 32 can be removed again by unlatching.

Hot laminating device 51 depicted next to frame plate 32 has a housing 57 penetrated, in the direction of arrow A, by a feedthrough conduit of low height. The feedthrough conduit has an insertion opening 58 on the side facing toward support plate 33, and an exit opening on the side facing away from it. In housing 57, hot laminating device 51 is embodied exactly like hot laminating device 13 in the case of office accessory 1 shown in FIGS. 1 and 2, to whose description reference is therefore made.

Hot laminating device 51 comprises control buttons 59, 60 with which hot laminating device 51 can be switched on and off. Heating of the laminating rollers is controlled via control button 59, while pressing the other control button 60 causes the drive system of the laminating rollers to be switched on, and also to be switched off again after the laminating operation.

Cold laminating device 52 located away from frame plate 32 corresponds to cold laminating device 22 in the case of office accessory 21 shown in FIG. 3. It has a housing 61 penetrated, in the direction of arrow E, by a feedthrough conduit of low height. The feedthrough conduit has an insertion opening 62 on the side facing toward support plate 33, and an exit opening on the side facing away from it. Inside housing 61, laminating device 52 is identical to laminating device 22 in the case of office accessory 21 shown in FIG. 3, to whose description reference is therefore made. The upper laminating roller is connected to an externally accessible rotary knob 63, so that cold laminating device 52 can be driven manually.

Both lamination and the trimming of sheet material proceed in a manner analogous to what has been described in office accessories 11, 21 depicted in FIGS. 1 to 3.

Office accessory 71 depicted in FIG. 5 comprises a substantially rectangular frame plate 72 whose horizontal upper side forms a support plate 73 for the placement of sheet material. The larger portion of support plate 73 is separated from the remaining portion, and forms a cover plate 74. It is mounted pivotably on one side via a hinge 75, so that it is pivotable out of a horizontal position, in which cover plate 74 is flush with support plate 73, into the substantially vertical position that is shown.

Located beneath cover plate 74 is a storage compartment 76 which is embodied as a storage tray 77 (shown here lifted up) that is open at the top and is hooked into frame plate 72. Storage tray 77 has a bottom 78 and is subdivided by ribs (labeled 79 by way of example), projecting up from bottom 78, in such a way that storage compartment 76 comprises multiple sub-compartments separated from one another. Office items or small office accessories can be accommodated in these sub-compartments. When storage tray 77 is hooked into frame plate 72, a clearance remains between frame bottom 80 and bottom 78 of storage tray 77. The space resulting therefrom can be used to accommodate sheet material 81.

On the side of frame plate 72 adjacent to hinge 75, the device depicted parallel thereto can be attached via complementary latching elements. These devices are a hot laminating device 82 (corresponding to hot laminating device 51 in the case of office accessory 31 shown in FIG. 4), a cold laminating device 83 (corresponding to cold laminating device 52 in the case of office accessory, 31 shown in FIG. 4), a rotary cutting device 84 (corresponding to rotary cutting device 35 in the case of office accessory 31 shown in FIG. 4), and a guillotine cutting device 85 (corresponding to guillotine cutting device 34 in the case of office accessory 31 shown in FIG. 4). Rotary cutting device 84 and guillotine cutting device 86 differ from rotary cutting device 35 and guillotine cutting device 34, respectively, in the case of office accessory 31 shown in FIG. 4 only in that they do not form a unit with frame plate 72, but rather are removable therefrom and attachable thereto via the aforesaid latching elements, alternatively in each case. Office accessory 71 can thus be joined to one of laminating devices 82, 83 or to rotary cutting device 84 or to guillotine cutting device 85.

It is understood that complementary latching elements can also be provided on the other sides of frame plate 72, so that office accessory 71 can be combined in any fashion with one of laminating devices 82, 83 and with rotary cutting device 84 and guillotine cutting device 85 so as to yield the combination depicted in FIG. 4. Instead of this, however, one of laminating devices 82, 83 can also be combined with one of cutting devices 84, 85 so as to yield the combinations shown in FIGS. 1 to 3.

I claim:

1. An office accessory (1, 21, 31, 71) for processing sheet material such as paper and/or films, having a support plate (3, 33, 73) to support the sheet material during the processing operation and having at least one cutting device (4, 34, 35, 84, 85) associated with the support plate (3, 33, 73),
wherein the office accessory (1, 21, 31, 71) additionally comprises at least one laminating device (14, 22, 51, 52, 82, 83) for laminating sheet material to at least one film.

2. The office accessory according to claim 1, wherein the laminating device (14, 22, 51, 52, 82, 83) is arranged or attachable on one side of the support plate (3, 33, 73).

3. The office accessory according to claim 2, wherein the laminating device (14, 22, 51, 52, 82, 83) comprises an insertion opening (13, 24, 58, 62), facing toward the support plate (3, 33, 73), for the introduction of sheet material and film(s).

4. The office accessory according to claim 3, wherein the lower side of the insertion opening (13, 24, 58, 62) is flush with the upper side of the support plate (3, 33, 73).

5. The office accessory according to claim 2, wherein the at least one cutting device (4, 34, 35) is arranged or attachable on one side of the support plate (3, 33), and the laminating device (14, 22, 51, 52) on a different side of the support plate (3, 33).

6. The office accessory according to claim 5, wherein the laminating device (14, 22, 51, 52) is arranged or attachable on a side of the support plate (3, 33) that extends transversely to the side on which the at least one cutting device (4, 34, 35) is arranged or attachable.

7. The office accessory according to claim 1, wherein the cutting device is embodied as a guillotine cutting device (4) that comprises a pivotably mounted knife arm (5) having a blade held thereon and a counterknife held in stationary fashion on the support plate (3).

8. The office accessory according to claim 1, wherein the cutting device is embodied as a rotary cutting device that comprises a knife carriage displaceable on a guide bar and a circular knife rotatably mounted in that carriage.

9. The office accessory according to claim 7, wherein the office accessory (31, 71) comprises both a guillotine cutting device (34, 85) and a rotary cutting device (35, 84).

10. The office accessory according to claim 9, wherein the guillotine cutting device (34) is arranged or attachable on one side of the support plate (33), and the rotary cutting device (35) on a different side of the support plate (33).

11. The office accessory according to claim 8, wherein the guillotine cutting device (34) and the rotary cutting device (35) are arranged or attachable so that they have cutting directions extending parallel to one another.

12. The office accessory according to claim 9, wherein the cutting device(s) (84, 85) is or are attachable or attached detachably on the support plate (73).

13. The office accessory according to claim 1, wherein the laminating device (51, 52, 82, 83) is attachable or attached detachably on the support plate (3).

14. The office accessory according to claim 12, wherein the cutting devices (84, 85) are embodied interchangeably with one another and/or with the laminating device (51, 52, 82, 83).

15. The office accessory according to claim 12, wherein the support plate (33, 73) on the one hand and the cutting device(s) (84, 85) and/or laminating device (51, 52, 82, 83) on the other hand comprise complementary retaining elements (53-56) with which it is attachable or attached on one side of the support plate (33, 73).

16. The office accessory according to claim 15, wherein the retaining elements (53-56) comprise latch devices.

17. The office accessory according to claim 16, wherein the latch devices are embodied in such a way that they are self-latching upon attachment of the cutting device(s) (84, 85) or laminating device (51, 52, 82, 83), but require a release actuation of the latch device upon removal.

18. The office accessory according to claim 1, wherein the laminating device is embodied as a hot laminating device (13, 51, 82).

19. The office accessory according to claim 1, wherein the laminating device is embodied as a cold laminating device (22, 52, 83).

20. The office accessory according to claim 19, wherein the laminating device (21) comprises laminating rollers that are drivable manually.

21. The office accessory according to claim 1, wherein at least one storage compartment (10, 76) is provided beneath the support plate (3, 33, 73).

22. The office accessory according to claim 21, wherein the storage compartment (10, 76) is provided at a horizontal spacing from the at least one cutting device (4, 34, 35, 84, 85).

23. The office accessory according to claim 21, wherein the at least one storage compartment (10, 76) is openable by the fact that the support plate (3, 33, 73) is at least partly removable in the region of the storage compartment (10, 76).

24. The office accessory according to claim 23, wherein at least a portion of the support plate (3, 33, 73) can be at least partly swung up or displaced laterally.

25. The office accessory according to claim 21, wherein the at least one storage compartment (10, 76), or a portion thereof, is sealed in airtight fashion when closed.

26. The office accessory according to claim 25, wherein the at least one storage compartment (10, 76) contains or comprises an airtight but openable box.

27. The office accessory according to claim 21, wherein the at least one storage compartment (10, 76) is subdivided into sub-compartments.

28. The office accessory according to claim 21, wherein the support plate (3, 33, 73) is at least locally transparent in the region of the at least one storage compartment (10, 76).

29. The office accessory according to claim 21, wherein the at least one storage compartment (10, 76) occupies at least 50% of the area of the support plate (3, 33, 73).

30. The office accessory according to claim 1, wherein the office accessory is equipped with a battery or rechargeable battery as an energy source for the laminating device.
